(19) United States
(12) Patent Application Publication
(10) Pub. No.: US 2003/0195652 A1
(43) Pub. Date: Oct. 16, 2003

(54) Publication vending apparatus

(76) Inventor: Bradley L. Gotfried, Hobe Sound, FL (US)

Correspondence Address: AKERMAN SENTERFITT, P.O. BOX 3188, WEST PALM BEACH, FL, 33402-3188, US

(21) Appl. No.: 10/455,106

(22) Filed: Jun. 5, 2003

Related U.S. Application Data
(63) Continuation of application No. 09/821,402, filed on Mar. 29, 2001, now abandoned.

(51) Int. Cl. G06F 17/00

(52) U.S. Cl. 700/235

(57) ABSTRACT

A publication vending apparatus and method includes a display and at least one input device for selecting a publication. A paper supply apparatus is provided. A printing device receives paper from paper supply apparatus and prints the pages of the publication using text and graphic information and printing information particular to the publication. A binding apparatus sorts and binds the paper into a publication.

### CROSS-REFERENCE TO RELATED APPLICATIONS

This application is a continuation of application Ser. No. 09/821,402, filed Mar. 29, 2001.

### STATEMENT REGARDING FEDERALLY SPONSORED RESEARCH OR DEVELOPMENT

(Not Applicable)

### BACKGROUND OF THE INVENTION

1. Field of the Invention

This invention relates generally to vending apparatus, and more particularly to vending apparatus for publications such as newspapers and magazines.

2. Background of the Invention

The distribution of publications such as magazines and newspapers has primarily been through traditional outlets such as stores, newsstands, and kiosks where customers manually select the publication and pay an attendant. Newspapers also have been vended through vending machines which require the customer to place coins into the machine so as to permit the removal of the newspaper from the machine. Vending machines have not been used for magazines owing to the greater variety of user choices, which renders a vending machine for magazines impractical in most cases. In all cases, the distribution and sale of publications, and particularly periodicals, is time consuming and inefficient owing to the frequency with which the publications must be replaced in stores and vending machines with newer issues. In the case of newspapers, this is every day. In the case of magazines, new issues appear usually every month or week. The bulk and weight of newspapers and magazines only increases the difficulty of stocking stores and vending machines with such publications. As dated issues are replaced by newer issues of the newspapers or periodicals, a great deal of waste is created and then must be removed and discarded or recycled. Finally, the fact of international travel and cross-cultural appeal of certain publications requires that the publications be printed in several languages. This requires duplication of the printing process, and further increases the amount of wasted paper, as many issues in different languages increase the likelihood of unpurchased issues. The space required to vend magazines and newspapers can be quite expensive. Owing to the proliferation of interest in various specialized magazines and newspapers, it is not uncommon for magazine and newspaper shelves to take up an entire wall of retail locations. The expense of maintaining these locations can be prohibitive in space-limited sites or sites where space is particularly expensive.

The electronic delivery of publications such as books, magazines and newspapers has been facilitated by the proliferation of users of the internet. Users are able, for free or with appropriate payment, to view and/or download and print portions of publications or entire publications. Many users, however, are uncomfortable reading publications from a video display terminal since this mode of reading is not particularly portable, and causes eye strain for many readers. The publications or portions are printed on the user's printer, which usually prints on one of only a few standard paper sizes. The printed versions of these publications on standard paper are not found to be desirable because they lack the original form and layout of the original publication. The reader is therefore cognizant that the reader has purchased something other than an original magazine or newspaper, and the layout intended for the original magazine or newspaper must often be modified.

### SUMMARY OF THE INVENTION

A publication vending apparatus includes a display and at least one input device for selecting information presented on the display. This information includes a publication. A printing device is provided. A plurality of paper storage containers are provided, with structure for delivering paper from the paper storage containers to the printing device. A computer memory stores the publication and delivers it to the printing device upon selection by the customer. Binding apparatus is provided for sorting and binding the paper together. The paper and binding are selected according to the selected publication, so as to at least approximate the overall appearance of the original publication.

The binding apparatus can be any suitable apparatus, including staples, adhesives, and other binding structures.

The vending apparatus has payment accepting structure for permitting the customer to pay for the publication(s) selected. The payment methods preferably include the acceptance of credit or debit cards, as well as paper money and coins.

In a preferred embodiment, the customer is permitted to select from a variety of publications such as magazines and newspapers. Most preferably, back issues of magazines and newspapers are also stored in memory and can be printed on site for the customer. Also, the publications can be stored in memory in various languages and a customer can select a language in which the publication will be printed.

The vending apparatus can be provided with computer memory which includes text and graphic data, language data, data for printing and sorting the publication, binding data and payment data. It is preferable, however, that the vending apparatus have connecting structure for connecting to a remote computer storing such data through an internet connection. In this manner, a great deal more information can be stored in a central computer without the need for having significant computer storage in each vending apparatus.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic diagram of a publication vending apparatus according to the invention.

FIG. 2 is a representation of a first graphical user interface display screen.

FIG. 3 is a representation of a second graphical user interface display screen.

FIG. 4 is a representation of a third graphical user interface display screen.

FIG. 5 is a representation of a fourth graphical user interface display screen.

FIG. 6 is a representation of a fifth graphical user interface display screen.

FIG. 7 is a representation of a sixth graphical user interface display screen.

FIG. 8 is a representation of a seventh graphical user interface display screen.

FIG. 9 is a flow diagram of a method according to the invention.

### DETAILED DESCRIPTION OF PREFERRED EMBODIMENT

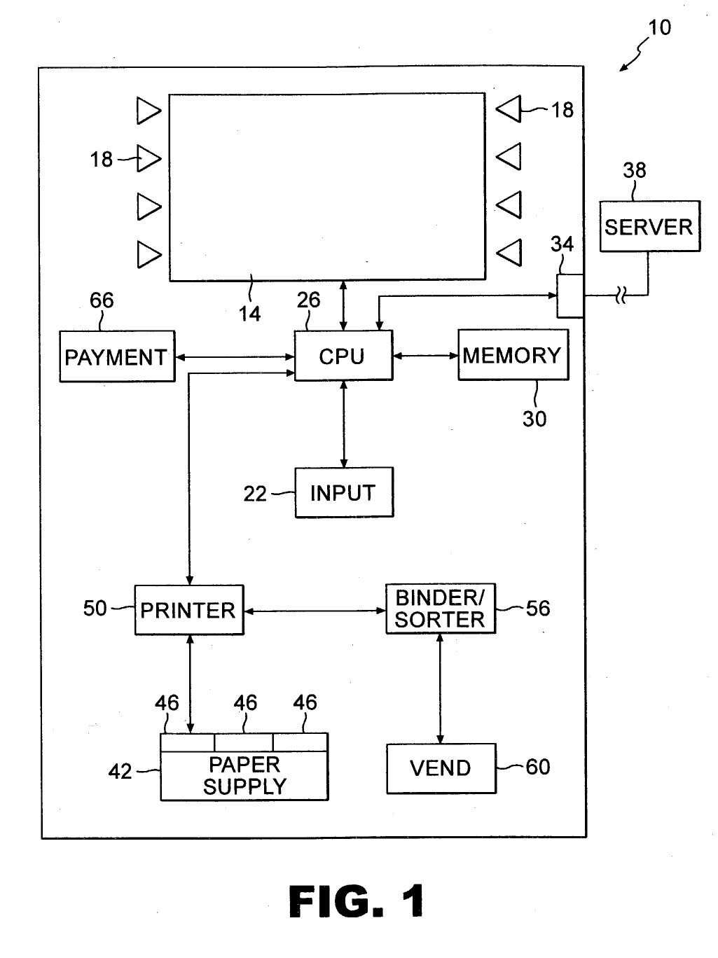

There is shown in FIG. 1 a schematic diagram of a publication vending apparatus 10 according to the invention. The apparatus has a graphical user interface (GUI) 14 which is commonly a video display terminal (VDT), however, it will be appreciated that other known interface devices could be substituted for the GUI 14. The GUI 14 is preferably capable of touch-screen user inputs, however, other inputs, such as push buttons 18, and other input devices 22, such as a keyboard, can be additionally or alternatively utilized.

A suitable processor such as CPU 26 is provided for operation of the publication vending apparatus 10. The CPU 26 can be any CPU suitable for the tasks described herein.

Computer memory 30 can be any suitable computer memory storage device. The amount of memory which will be necessary will depend on the length and number of different publications which are retained in memory. Alternatively, a computer communications connection 34 can be utilized to connect to a computer communications network server 38. The server 38 can communicate with any suitable computer communications network, including any privately or publicly accessible network. For example, the privately and publicly accessible networks can include any number or combination of the following: local area networks, wide area networks, metropolitan area networks, and global area networks. The Internet and Bitnet are examples of global area networks. Examples of privately accessible networks include America Online®, Compuserve®, and Prodigy®. It is understood that the invention is not limited to any of these examples, as any other computer communications network is also within the scope of the invention.

Connection to the server 38 allows the transfer of data, such as through an uploading or downloading of data. Thus, use of such a server allows the memory 30 to be significantly smaller in scale because large volumes of needed data can be downloaded from a remote memory.

Selection of a particular publication results in printing of that publication. Most preferably, the publication is printed substantially in the size and format of the original publication. Thus, a newspaper can be printed on newsprint of a size approximating that of the newspaper which is sold in newsstands and delivered. Article layouts, pagination and the likes are also preferably duplicated. Magazines can be printed in the particular size format in which they are sold in stores or mailed to consumers. In order to accomplish such a layout, a paper supply apparatus 42 can have a plurality of paper bins 46. The paper bins 46 can include newsprint and magazine stock paper in a variety of different sizes corresponding to the magazines and newspaper which can be selected by a customer. Upon selection of a particular publication, the appropriate paper can be transferred to a suitable printer 50. The printer 50 can be capable of printing in print sizes, fonts, and styles which match those of the original publication that is sold in stores, vending machines and through direct mailing. The printer 50 is preferably photo quality, so as to permit the reproduction of graphics, photographs and the like where they appear in the original publication.

The printed pages can then transferred from the printer 50 to a binder/sorter 56. The binder/sorter 56 can receive printed leaves, and assemble and bind these leaves in a manner which is as close to the original as possible, and preferably substantially duplicates the original. The binder/sorter 56 can utilize staples, adhesives, or other suitable means known for binding publications. Also, in the case of newspapers, the binding can be accomplished by sorting the page in the proper order and creasing them in appropriate places. The assembled publication can be transferred from the binder/sorter 56 to an appropriate vending position 60 where the publication is delivered to the customer.

Payment for the publication can be effected in any suitable manner. For example, payment can be accomplished by inputting suitable payment information through a suitable payment input device 66. The payment input device 66 can receive cash, coins, or credit/debit cards. This information can be passed to the CPU 26, where it can be processed to permit the creation and delivery of the publication for the customer. Credit/debit card information can be validated through the computer communications connection 34 and suitable payment validation processing, either at the server 38 or at an alternative location. Also, payment information can be input through the touch screen 14 or the input device 22.

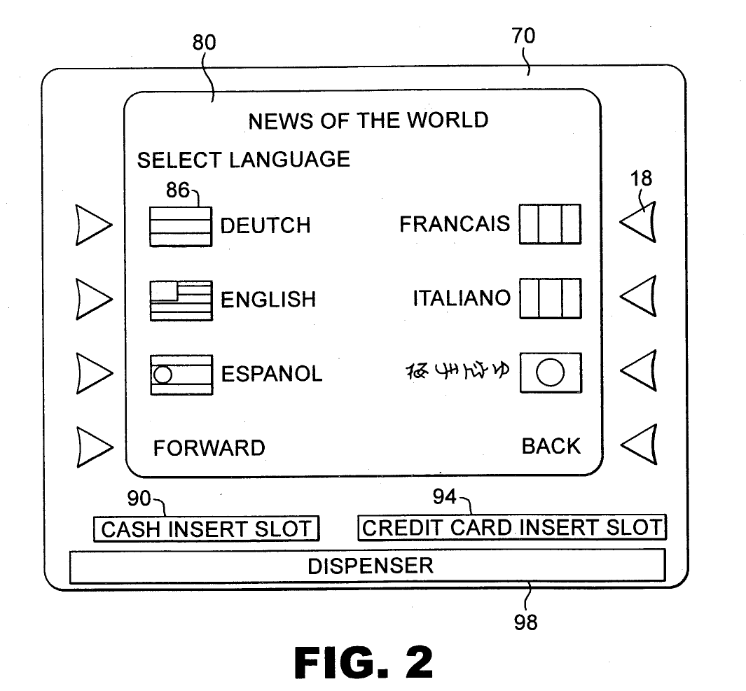

A GUI 14 is shown in FIG. 2 as a VDT screen 70. In the example of FIG. 2, the VDT screen 70 has push buttons 18, as well as a touch screen 80 with graphical displays 86. A customer can enter an appropriate selection by contacting the push buttons 18 and/or touching the touch screen 80. It is understood that the invention is not limited in this regard, however, as a customer may communicate a selection in any suitable manner. Payment can be effected through a cash insert slot 90, or a credit card insert slot 94. The publication can be delivered to the customer through the dispenser location 98. The display screen shown in FIG. 2 allows the customer to select a language for the publication that will be ordered, as well as for the user information that will be displayed on the screen 80.

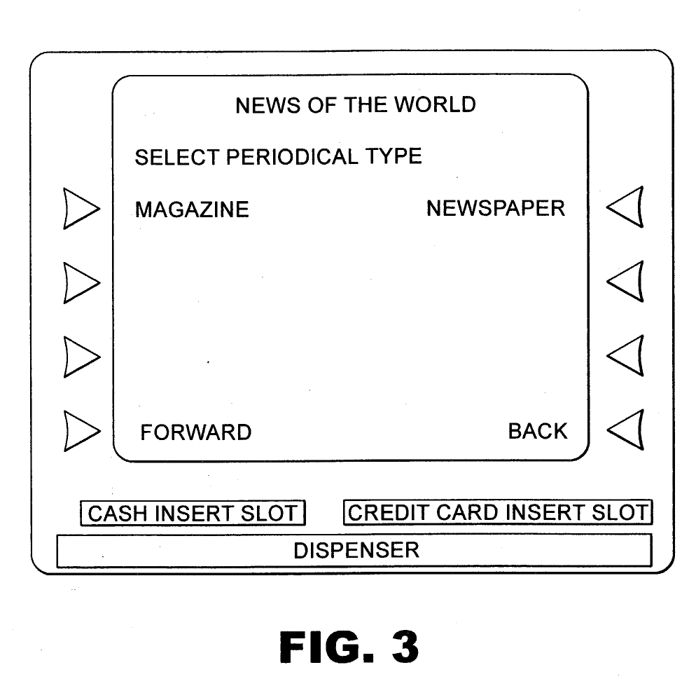

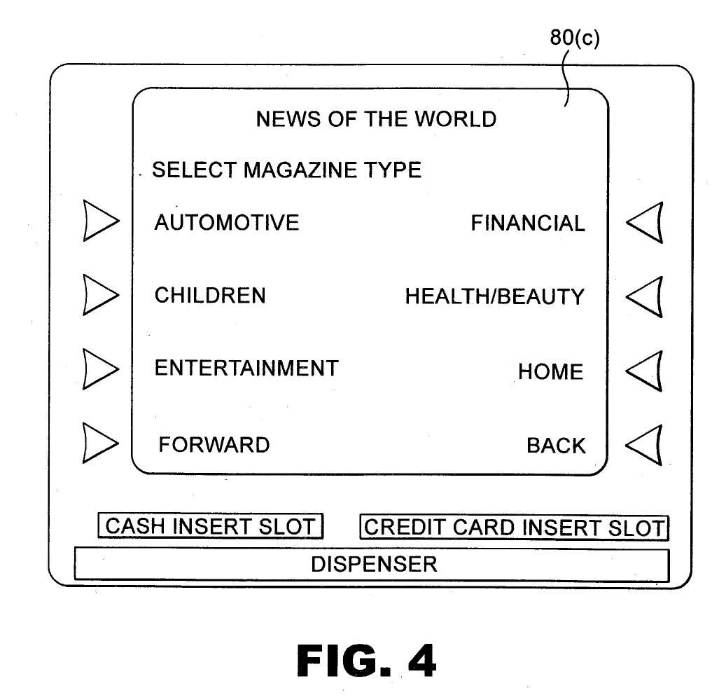

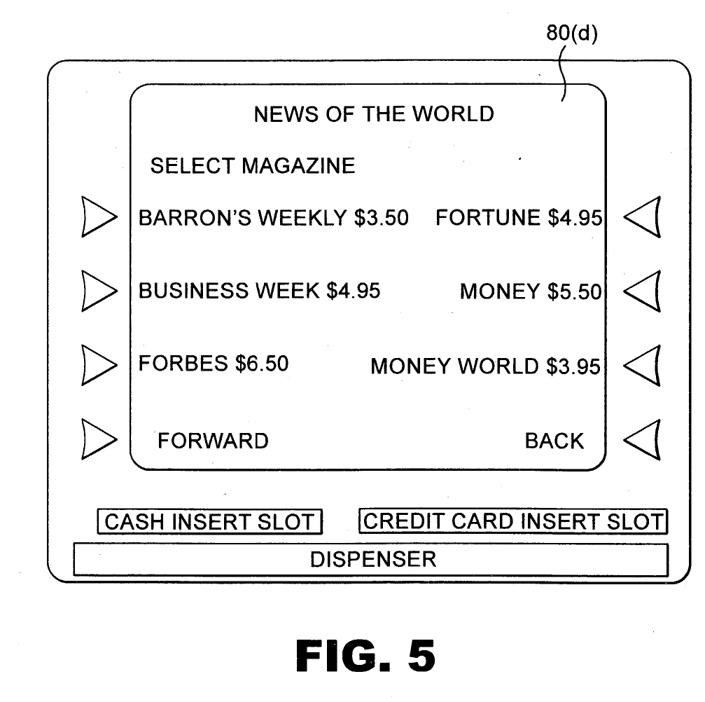

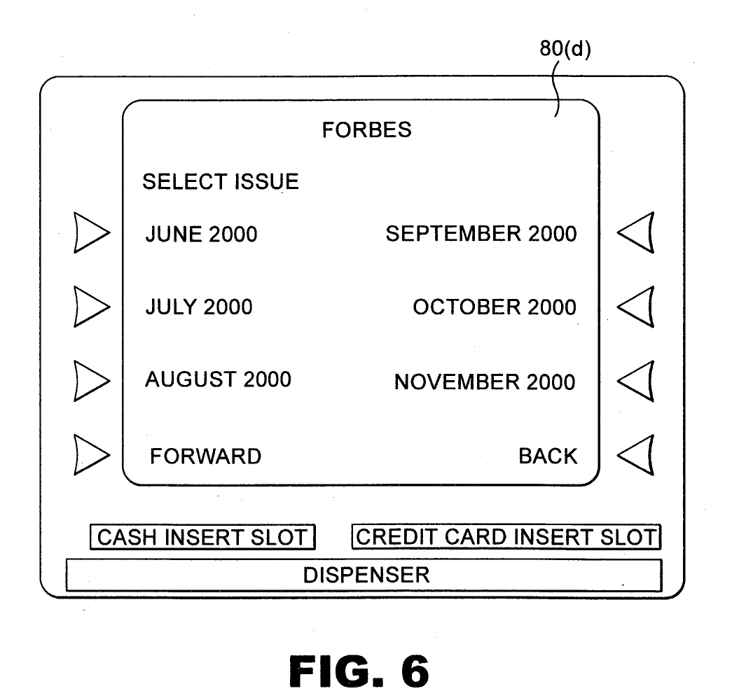

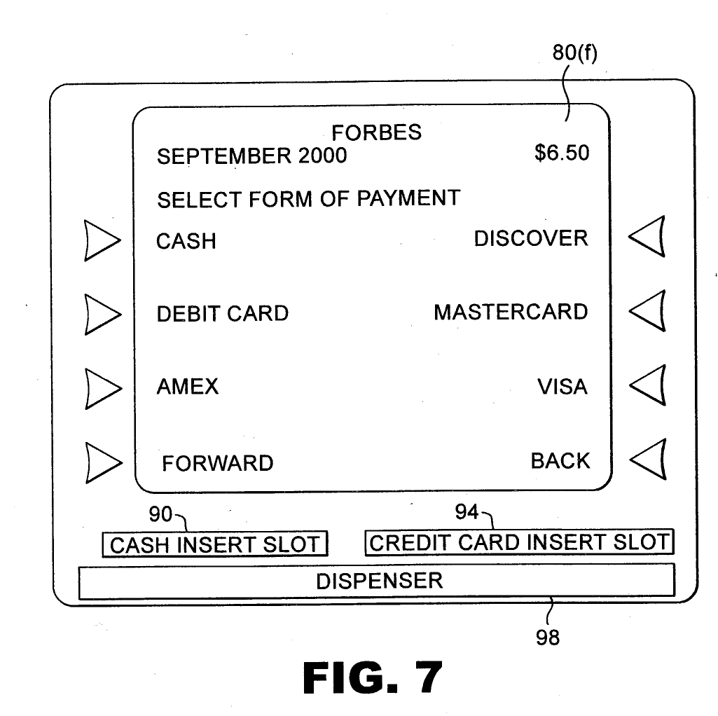

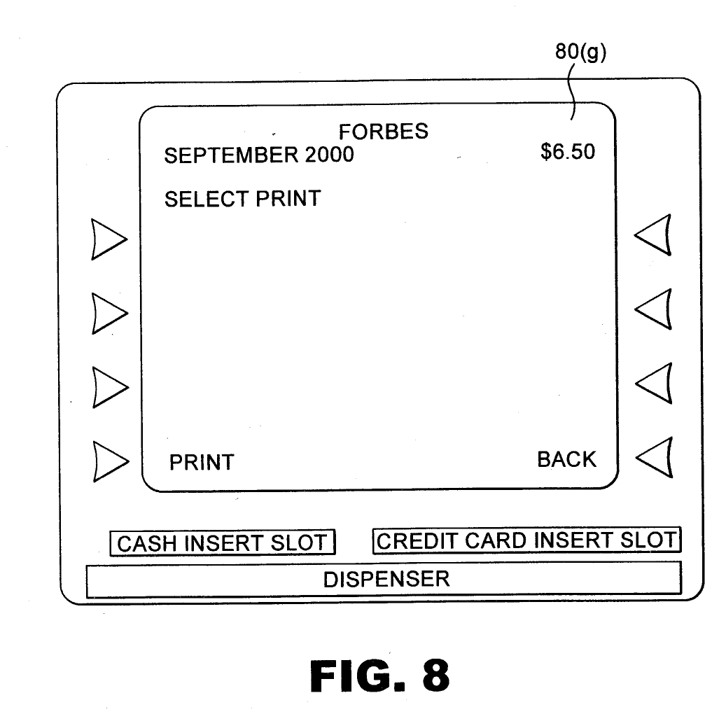

FIG. 3 depicts a second screen, where the customer selects the type of publication which the customer desires. In the screen shown, the customer selects between a magazine and a newspaper, although the invention is not limited in this regard as any type of publication is acceptable. If the customer has selected a magazine, screen 80(c) of FIG. 4 provides topical information regarding the type of magazine that the customer wishes to see. After the consumer has selected the type of magazine which is desired, the screen 80(d) shown in FIG. 5 displays a selection of magazine titles which are available from the publication vending apparatus 10, as shown in FIG. 5. In FIG. 6, the screen 80(e) permits the customer to select the particular issue of the magazine which the customer wishes to purchase. It will be appreciated that further screens and information can be provided to the customer. These include screens which, when the particular issue is selected, will display the Table of Contents, or perhaps a portion of the publication to assist the customer in determining whether the customer wishes to purchase that issue. If the customer's purchase is complete, a screen 80(f) appears as shown in FIG. 7, which permits the user to select the payment method desired by the customer. The customer can insert cash through an appropriate cash insert slot 90, or a credit/debit card through an appropriate credit/debit card slot 94. A receipt can be displayed in a screen 80(g) shown in FIG. 8. The receipt can also be printed and delivered to the customer through the dispenser 98 along with the requested publication. It is understood that the screens described above are merely exemplary, as the invention is not limited to these screens or the order in which these screens have been described.

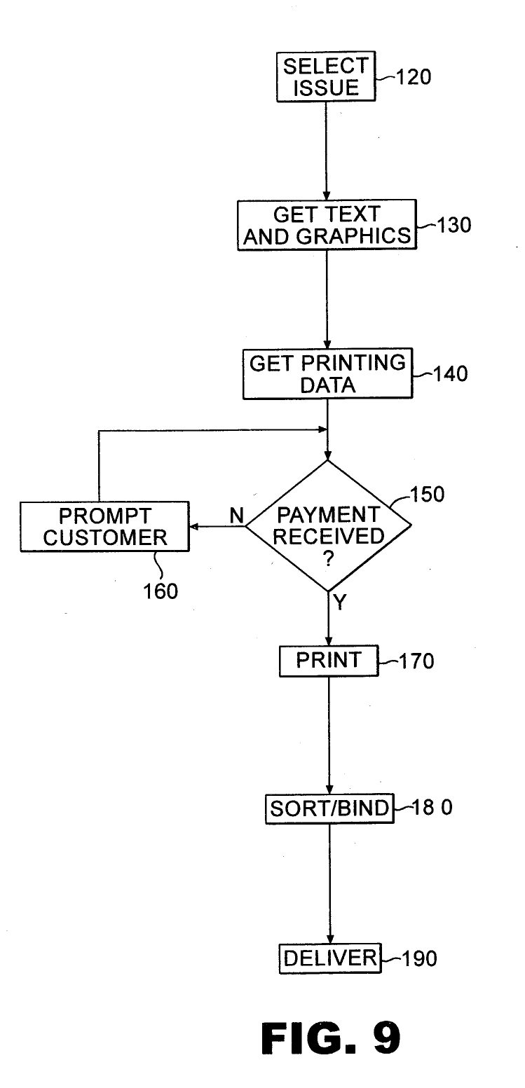

A method according to the invention is illustrated in FIG. 9. The method begins at a block 120 in which the customer selects an issue of a publication including the particular issue, whether current or a past issue. A language can also be selected. The CPU 26 can obtain text and graphics information for that issue in a block 130. The printing data is selected in block 140. The printing data can include the type of paper which will be necessary for each page of the publication, formatting information for placing the text and graphics on each page, and information relating to binding the publication. Prior to printing, it may be desirable to query whether payment has been received in a step 150. If not, the customer can be prompted in step 160 to enter payment and step 150 can be repeated until payment is received. Upon receipt of payment, the publication is printed in step 170. The publication is then sorted and bound in step 180. Finally, the publication is delivered to the customer in a step 190.

This invention can take other specific forms without departing from the spirit or essential attributes thereof, and accordingly, reference should be had to the following claims, rather than to the foregoing specification, as indicating the scope of the invention.

What is claimed is:

1. A publication vending apparatus, comprising:
a display;
at least one input device for selecting a publication;
a paper supply apparatus;
a printing device;
structure for delivering paper from the paper supply apparatus to the printing device, and
sorting and binding apparatus;
said paper being printed and formatted according to the selected publication.

2. The publication vending apparatus of claim 1, wherein said input device includes structure for selecting a language, said printing device printing said publication in said language.

3. The publication vending apparatus of claim 1, wherein said binding apparatus comprises at least one stapling apparatus.

4. The publication vending apparatus of claim 1, wherein said input device includes structure for accepting payment from said customer.

5. The publication vending apparatus of claim 1, wherein said vending apparatus comprises at least one global computer information network connection, said vending apparatus obtaining at least one of publication text and graphic data, language data, printing data, binding data and payment data through said connection.

6. The publication vending apparatus of claim 1, wherein said printing device is adapted to printing newspapers.

7. The publication vending apparatus of claim 1, wherein said printing device is adapted to print magazines.

8. The publication vending apparatus of claim 1, wherein said paper supply apparatus comprises a plurality of paper storage containers.

9. A method for vending publications, comprising the steps of:
receiving publication selection data from a customer;
obtaining text and graphics information for said publication;
obtaining printing data for said publication;
printing pages of said publication;
sorting and binding said pages; and, delivering said printed publication to said customer.
